(19) United States
(12) Patent Application Publication
(10) Pub. No.: US 2026/0252508 A1
(43) Pub. Date: Aug. 27, 2026

(54) VEHICLE-MOUNTED DEVICE AND INFORMATION PROCESSING CIRCUIT

(71) Applicants: AutoNetworks Technologies, Ltd., Yokkaichi-shi (JP); Sumitomo Wiring Systems, Ltd., Yokkaichi-shi (JP); Sumitomo Electric Industries, Ltd., Osaka (JP)

(72) Inventor: Wenhan ZHANG, Yokkaichi-shi, Mie (JP)

(73) Assignees: AutoNetworks Technologies, Ltd., Yokkaichi-shi (JP); Sumitomo Wiring Systems, Ltd., Yokkaichi-shi (JP); Sumitomo Electric Industries, Ltd., Osaka (JP)

(21) Appl. No.: 19/548,131

(22) Filed: Feb. 24, 2026

(30) Foreign Application Priority Data
Feb. 27, 2025 (JP) 2025-030297

(51) Int. Cl. G06F 13/28

(52) U.S. Cl. CPC G06F 13/28; G06F 2213/28

(57) ABSTRACT

An object is to maintain harmony between the timing of buffer access by a processor and the timing of buffer access by direct memory access. A vehicle-mounted device includes: an information processing circuit; and a connector configured to be connected to an associated device related to processing of the information processing circuit, wherein the information processing circuit includes: a first buffer; a second buffer; a third buffer; a processor configured to read or write data from or to each of the first buffer, the second buffer, and the third buffer; an interface connected to the connector and configured to perform at least one of input and output of data with the associated device; and a direct memory access controller configured to transfer data between a register included in the interface and each of the first buffer, the second buffer, and the third buffer.

### CROSS-REFERENCE TO RELATED APPLICATIONS

This application claims priority of Japanese Patent Application No. JP 2025-030297 filed on February 27, 2025, the contents of which are incorporated herein.

### TECHNICAL FIELD

The present disclosure relates to a vehicle-mounted device and an information processing circuit.

### BACKGROUND

Vehicles are equipped with a variety of vehicle-mounted devices, including control system electronic control units (ECUs) that control the engine, transmission, etc., body system ECUs that control the headlights, power windows, etc., and information system ECUs for navigation devices, multimedia equipment, etc. Such vehicle-mounted devices are connected to a vehicle-mounted network and can communicate with each other. These vehicle-mounted devices are equipped with microcontrollers (microcontroller units (MCUs)), which execute application programs to implement various functions.

JP 2015-132894A discloses an MCU that performs data transfer by direct memory access (DMA) between a random access memory (RAM) and a peripheral circuit including a serial communication interface for communicating with external devices such as sensors.

JP 2015-132894A is an example of related art.

### SUMMARY

In a vehicle-mounted device required to have real-time performance, such as control related to vehicle traveling, an MCU performs real-time processing. In an MCU, a CPU and a DMA controller harmoniously perform input/output of data to and from a buffer in a RAM in a certain cycle. However, if an interrupt occurs in the CPU, the harmony between the timing of buffer access by the CPU and the timing of buffer access by DMA may be disrupted, for example, data transmission from the buffer by DMA may start before the CPU completes writing to the buffer, and normal processing may be hindered.

A vehicle-mounted device according to an aspect of the present disclosure includes: an information processing circuit; and a connector configured to be connected to an associated device related to processing of the information processing circuit, wherein the information processing circuit includes: a first buffer; a second buffer; a third buffer; a processor configured to read or write data from or to each of the first buffer, the second buffer, and the third buffer; an interface connected to the connector and configured to perform at least one of input and output of data with the associated device; and a direct memory access controller configured to transfer data between a register included in the interface and each of the first buffer, the second buffer, and the third buffer, the processor is configured to read or write data from or to the first buffer in an ith main cycle, read or write data from or to the second buffer in an (i+1)th main cycle, and read or write data from or to the third buffer in an (i+2)th main cycle, and the direct memory access controller is configured to transfer data between the first buffer and the register during a period from an intermediate point of the (i+1)th main cycle to an intermediate point of the (i+2)th main cycle, transfer data between the second buffer and the register during a period from an intermediate point of the (i+2)th main cycle to an intermediate point of an (i+3)th main cycle, and transfer data between the third buffer and the register during a period from an intermediate point of the (i+3)th main cycle to an intermediate point of an (i+4)th main cycle, where i is a natural number variable.

According to the present disclosure, even if an interrupt occurs in the processor, harmony between the timing of buffer access by the processor and the timing of buffer access by direct memory access can be maintained.

### BRIEF DESCRIPTION OF THE DRAWINGS

FIG. 1 is a block diagram illustrating an example of the configuration of an ECU according to an embodiment;

FIG. 2 is a block diagram illustrating an example of the hardware configuration of an MCU according to the embodiment;

FIG. 3 is a diagram schematically illustrating an example of data flow in the MCU;

FIG. 4 is a timing chart illustrating an example of buffer access timing in a double buffer configuration; and

FIG. 5 is a timing chart illustrating an example of buffer access timing in a triple buffer configuration.

### DETAILED DESCRIPTION OF PREFERRED EMBODIMENTS

An overview of embodiments of the present disclosure will be listed and described.

(1) A vehicle-mounted device according to an embodiment includes: an information processing circuit; and a connector configured to be connected to an associated device related to processing of the information processing circuit, wherein the information processing circuit includes: a first buffer; a second buffer; a third buffer; a processor configured to read or write data from or to each of the first buffer, the second buffer, and the third buffer; an interface connected to the connector and configured to perform at least one of input and output of data with the associated device; and a direct memory access controller configured to transfer data between a register included in the interface and each of the first buffer, the second buffer, and the third buffer, the processor is configured to read or write data from or to the first buffer in an ith main cycle, read or write data from or to the second buffer in an (i+1)th main cycle, and read or write data from or to the third buffer in an (i+2)th main cycle, and the direct memory access controller is configured to transfer data between the first buffer and the register during a period from an intermediate point of the (i+1)th main cycle to an intermediate point of the (i+2)th main cycle, transfer data between the second buffer and the register during a period from an intermediate point of the (i+2)th main cycle to an intermediate point of an (i+3)th main cycle, and transfer data between the third buffer and the register during a period from an intermediate point of the (i+3)th main cycle to an intermediate point of an (i+4)th main cycle, where i is a natural number variable.

Thus, a blank period is created between a period in which the processor accesses a buffer and a period in which the direct memory access controller accesses the buffer. Accordingly, even if an interrupt occurs in the processor, harmony between the timing of buffer access by the processor and the timing of buffer access by direct memory access can be maintained.

(2) In the above (1), the information processing circuit may be configured to output data to the associated device, the first buffer may include a first transmit buffer, the second buffer may include a second transmit buffer, the third buffer may include a third transmit buffer, and the direct memory access controller is configured to: transfer data written to the first transmit buffer by the processor in the ith main cycle, from the first transmit buffer to the register during the period from the intermediate point of the (i+1)th main cycle to the intermediate point of the (i+2)th main cycle; transfer data written to the second transmit buffer by the processor in the (i+1)th main cycle, from the second transmit buffer to the register during the period from the intermediate point of the (i+2)th main cycle to the intermediate point of the (i+3)th main cycle; and transfer data written to the third transmit buffer by the processor in the (i+2)th main cycle, from the third transmit buffer to the register during the period from the intermediate point of the (i+3)th main cycle to the intermediate point of the (i+4)th main cycle. Thus, when data written to a transmit buffer by the processor is output to the associated device, a blank period is created between a period in which the processor accesses the transmit buffer and a period in which the direct memory access controller accesses the corresponding transmit buffer. Accordingly, even if an interrupt occurs in the processor, harmony between the timing of access to the transmit buffer by the processor and the timing of access to the transmit buffer by direct memory access can be maintained.

(3) In the above (2), the associated device may include an actuator, and the data may be data for controlling the actuator. Thus, even if an interrupt occurs in the processor, the actuator can be controlled normally.

(4) In any one of the above (1) to (3), the associated device may output data to the information processing circuit, the first buffer may include a first receive buffer, the second buffer may include a second receive buffer, the third buffer may include a third receive buffer, and the processor may be configured to: read, from the first receive buffer, output data from the associated device that has been transferred from the register to the first receive buffer by the direct memory access controller during a period from an intermediate point of a (i−2)th main cycle to an intermediate point of a (i−1)th main cycle, in the ith main cycle; read, from the second receive buffer, output data from the associated device that has been transferred from the register to the second receive buffer by the direct memory access controller during a period from an intermediate point of the (i−1)th main cycle to an intermediate point of the ith main cycle, in the (i+1)th main cycle; and read, from the third receive buffer, output data from the associated device that has been transferred from the register to the third receive buffer by the direct memory access controller during a period from an intermediate point of the ith main cycle to an intermediate point of the(i+1)th main cycle, in the (i+2)th main cycle. Thus, when the processor reads, from a receive buffer, data output from the associated device, a blank period is created between a period in which the direct memory access controller accesses the receive buffer and a period in which the processor accesses the receive buffer. Accordingly, even if an interrupt occurs in the processor, harmony between the timing of access to the receive buffer by the processor and the timing of access to the receive buffer by direct memory access can be maintained.

(5) In the above (4), the associated device may include a sensor, and the data may be data output from the sensor. Thus, even if an interrupt occurs in the processor, processing that uses data output from the sensor can be performed normally.

(6) An information processing circuit according to an embodiment includes: a first buffer; a second buffer; a third buffer; a processor configured to read or write data from or to each of the first buffer, the second buffer, and the third buffer; an interface connected to an associated device and configured to perform at least one of input and output of data with the associated device; and a direct memory access controller configured to transfer data between a register included in the interface and each of the first buffer, the second buffer, and the third buffer, wherein the processor is configured to read or write data from or to the first buffer in an ith main cycle, read or write data from or to the second buffer in an (i+1)th main cycle, and read or write data from or to the third buffer in an (i+2)th main cycle, and the direct memory access controller is configured to transfer data between the first buffer and the register during a period from an intermediate point of the (i+1)th main cycle to an intermediate point of the (i+2)th main cycle, transfer data between the second buffer and the register during a period from an intermediate point of the (i+2)th main cycle to an intermediate point of an (i+3)th main cycle, and transfer data between the third buffer and the register during a period from an intermediate point of the (i+3)th main cycle to an intermediate point of an (i+4)th main cycle, where i is a natural number variable.

Thus, a blank period is created between a period in which the processor accesses a buffer and a period in which the direct memory access controller accesses the buffer. Accordingly, even if an interrupt occurs in the processor, harmony between the timing of buffer access by the processor and the timing of buffer access by direct memory access can be maintained.

The present disclosure can be implemented not only as the vehicle-mounted device having the characteristic configuration described above and as the information processing circuit having the characteristic configuration described above, but also as a vehicle-mounted system including the vehicle-mounted device, as a buffer access method including characteristic steps, or as a semiconductor integrated circuit including part or all of the above-described information processing circuit.

Embodiments of the present disclosure will be described in detail below with reference to the drawings. The embodiments described below may be at least partly combined in any manner.

### ECU

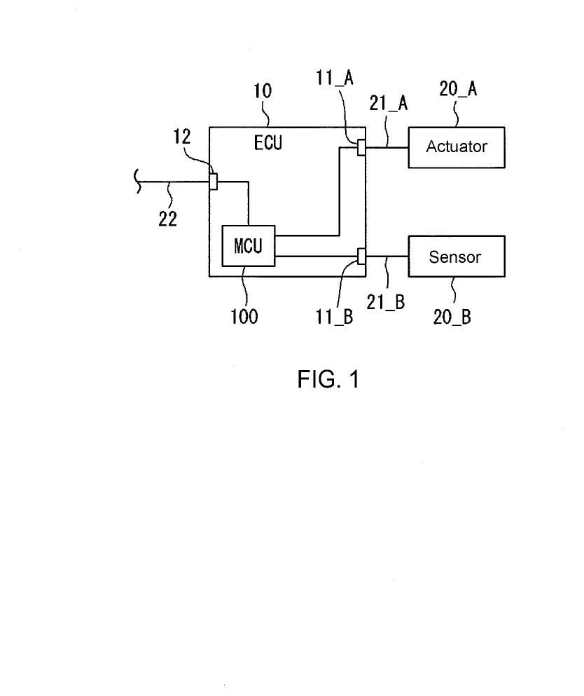

FIG. 1 is a block diagram illustrating an example of the configuration of an ECU according to an embodiment. An ECU 10 is mounted on a vehicle.

The ECU 10 according to this embodiment includes an MCU 100, connectors 11_A and 11_B, and a network interface 12. The ECU 10 is an example of a “vehicle-mounted device”.

The MCU 100 executes application software and implements functions of the ECU 10 (for example, control of an actuator). The MCU 100 is an example of an “information processing circuit”. The configuration of the MCU 100 will be described later.

The connectors 11_A and 11_B are connectors for data input/output. The connector 11_A is connected to an actuator 20_A via a signal line 21_A. The connector 11_B is connected to a sensor 20_B via a signal line 21_B. The actuator 20_A and the sensor 20_B are examples of external devices. Each of the connectors 11_A and 11_B is connected to the MCU 100 inside the ECU 10 via a signal line.

The network interface 12 conforms to a specific communication protocol (for example, control area network (CAN) or Ethernet (registered trademark)). The network interface 12 is connected to a vehicle-mounted network via a communication line 22. A plurality of ECUs are connected to the vehicle-mounted network. The plurality of ECUs connected to the vehicle-mounted network can communicate with each other using the specific communication protocol. The plurality of ECUs connected to the vehicle-mounted network form a vehicle-mounted system. In the vehicle-mounted system, the plurality of ECUs cooperate to implement specific functions or services. The network interface 12 is connected to the MCU 100 inside the ECU 10 via a signal line.

### MCU

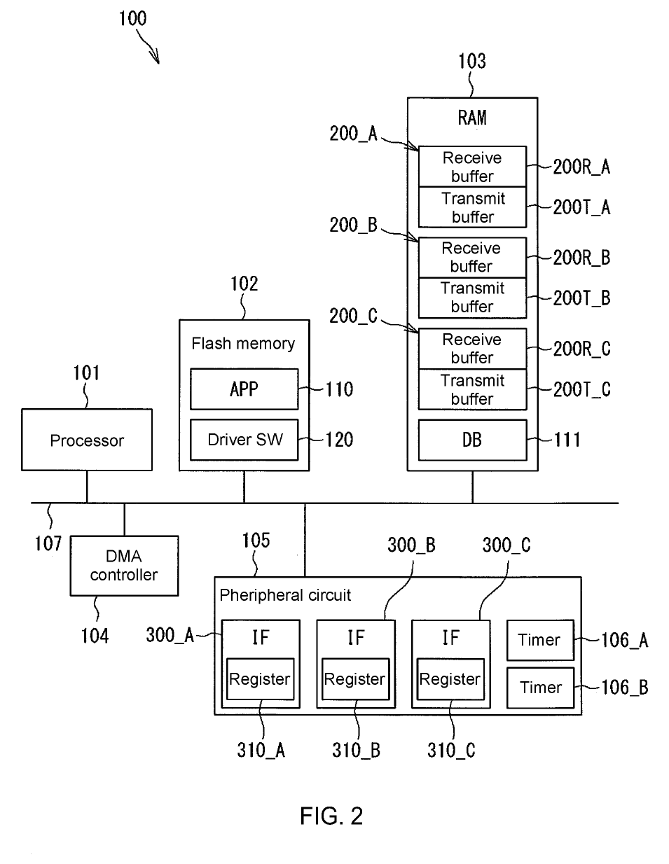

FIG. 2 is a block diagram illustrating an example of the hardware configuration of the MCU according to the embodiment.

The MCU 100 is, for example, a single-chip semiconductor integrated circuit. The MCU 100 includes a processor 101, a flash memory 102, a RAM 103, a DMA controller 104, and a peripheral circuit 105. The processor 101, the flash memory 102, the RAM 103, the DMA controller 104, and the peripheral circuit 105 are connected to each other via a bus 107.

The RAM 103 is a volatile memory and is, for example, a semiconductor memory such as a static random access memory (SRAM) or a dynamic random access memory (DRAM). The flash memory 102 is a non-volatile memory and is, for example, a semiconductor memory.

The processor 101 is, for example, a central processing unit (CPU). The processor 101 is not limited to a CPU. The processor 101 may be a graphics processing unit (GPU). A specific example of the processor 101 is a multi-core processor. The processor 101 may be a single-core processor. The processor 101 may include a plurality of processors or cores and be capable of executing parallel processing. The processor 101 is configured to execute computer programs. For example, the processor 101 may include an application specific integrated circuit (ASIC) in part, or include programmable hardware such as a field programmable gate array (FPGA) or a complex programmable logic device (CPLD) in part.

The flash memory 102 stores application software (hereinafter also referred to as “APP”) 110, which is a computer program, and data used for executing the APP 110. The APP 110 can be stored in a recording medium such as a flash memory, ROM, or CD-ROM. The processor 101 implements specific functions by executing the APP 110.

The peripheral circuit 105 enables the MCU 100 to implement various functions. The peripheral circuit 105 includes interfaces (hereinafter also referred to as “IFs”) 300_A, 300_B, and 300_C. Each of the IFs 300_A, 300_B, and 300_C is a circuit that performs at least one of input and output of data with a connected device. Examples of the IFs 300_A, 300_B, and 300_C include input/output interfaces such as general-purpose input/output ports (GPIOs), analog/digital converters, and pulse width modulation (PWM) interfaces, and serial communication interfaces conforming to serial communication standards such as universal asynchronous receiver/transmitter (UART), inter-integrated circuit (I2C), and Serial Peripheral Interface (SPI).

The IF 300_A is connected to the connector 11_A via a signal line. That is, the IF 300_A is connected to the actuator 20_A. The IF 300_B is connected to the connector 11_B via a signal line. That is, the IF 300_B is connected to the sensor 20_B. The IF 300_C is connected to the network interface 12 via a signal line.

The IF 300_A includes a register 310_A, the IF 300_B includes a register 310_B, and the IF 300_C includes a register 310_C. Each of the registers 310_A, 310_B, and 310_C is a storage circuit that temporarily stores input/output data. In detail, the register 310_A temporarily stores data output to the actuator 20_A. The register 310_B temporarily stores data input from the sensor 20_B. The register 310_C temporarily stores data received from the vehicle-mounted network and data transmitted to the vehicle-mounted network.

The DMA controller 104 can directly access the RAM 103 without intervention by the processor 101. The DMA controller 104 can also access each of the registers 310_A, 310_B, and 310_C. In detail, the DMA controller 104 controls DMA-based data transfers between the RAM 103 and the registers 310_A, 310_B, and 310_C (i.e., data transfers from the RAM 103 to the registers 310_A, 310_B, and 310_C, and data transfers from the registers 310_A, 310_B, and 310_C to the RAM 103).

The RAM 103 includes buffers 200_A, 200_B, and 200_C. Each of the buffers 200_A, 200_B, and 200_C is a storage region that temporarily stores data input to the processor 101 and data output from the processor 101.

The buffer 200_A includes a receive buffer 200R_A and a transmit buffer 200T_A. The buffer 200_B includes a receive buffer 200R_B and a transmit buffer 200T_B. The buffer 200_C includes a receive buffer 200R_C and a transmit buffer 200T_C.

Each of the receive buffers 200R_A, 200R_B, and 200R_C temporarily stores data input to the processor 101. The processor 101 can read data from each of the receive buffers 200R_A, 200R_B, and 200R_C. Each of the transmit buffers 200T_A, 200T_B, and 200T_C temporarily stores data output from the processor 101. The processor 101 can write data to each of the transmit buffers 200T_A, 200T_B, and 200T_C.

The RAM 103 is provided with a database (hereinafter also referred to as “DB”) 111. The DB 111 stores data input to the APP 110 and data output from the APP 110.

The flash memory 102 further stores driver software (hereinafter also referred to as “driver SW”) 120 and data used for executing the driver SW 120. The driver SW is a computer program for enabling the processor 101 to access each of the buffers 200_A, 200_B, and 200_C and the DB 111.

The peripheral circuit 105 further includes timers 106_A and 106_B. The timer 106_A measures time and outputs a notification to the processor 101 for each main cycle used for executing the APP 110. The timer 106_B measures time and outputs a notification to the DMA controller 104 for each sub-cycle used by the DMA controller 104. In this embodiment, the main cycle and the sub-cycle have the same length but different phases.

### DATA FLOW IN MCU

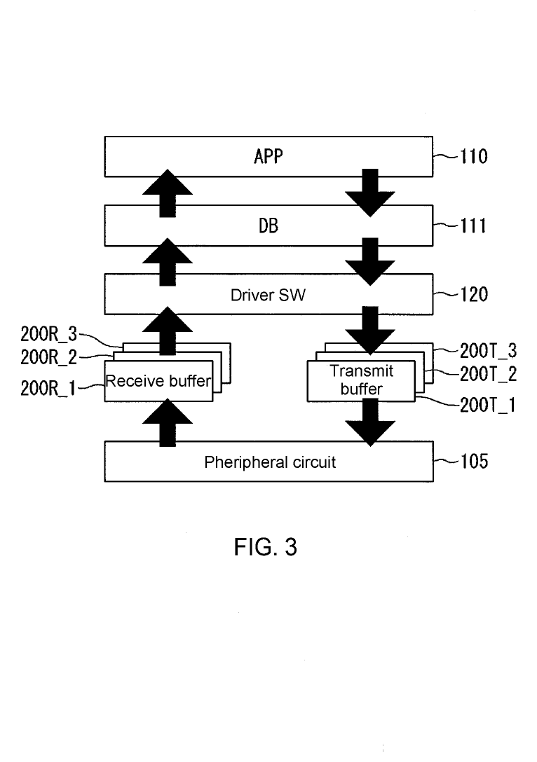

FIG. 3 is a diagram schematically illustrating an example of the data flow in the MCU.

The data flow in the MCU will be described by taking as an example a case where the APP 110 outputs control data for the actuator 20_A using detection data output from the sensor 20_B.

Detection data output from the sensor 20_B is input to the peripheral circuit 105 and stored in the register 310_B of the IF 300_B. The detection data stored in the register 310_B is transferred from the register 310_B to one of the receive buffers 200R_A, 200R_B, and 200R_C by DMA.

The driver SW 120 executed by the processor 101 reads the detection data from the one of the receive buffers 200R_A, 200R_B, and 200R_C, and stores the read detection data in the DB 111.

The APP 110 executed by the processor 101 reads the detection data from the DB 111. The APP 110 generates control data for controlling the actuator 20_A based on the read detection data, and stores the generated control data in the DB 111.

The driver SW 120 executed by the processor 101 reads the control data from the DB 111, and stores the read control data in one of the transmit buffers 200T_A, 200T_B, and 200T_C.

The control data stored in the one of the transmit buffers 200T_A, 200T_B, and 200T_C is transferred from the one of the transmit buffers 200T_A, 200T_B, and 200T_C to the register 310_A of the IF 300_A in the peripheral circuit 105 by DMA. The control data stored in the register 310_A is output to the actuator 20_A and used for controlling the actuator 20_A.

The above-described data input/output cycle is repeatedly performed between the MCU 100 and the associated devices (the actuator 20_A and the sensor 20_B).

### BUFFER ACCESS

### Double Buffer

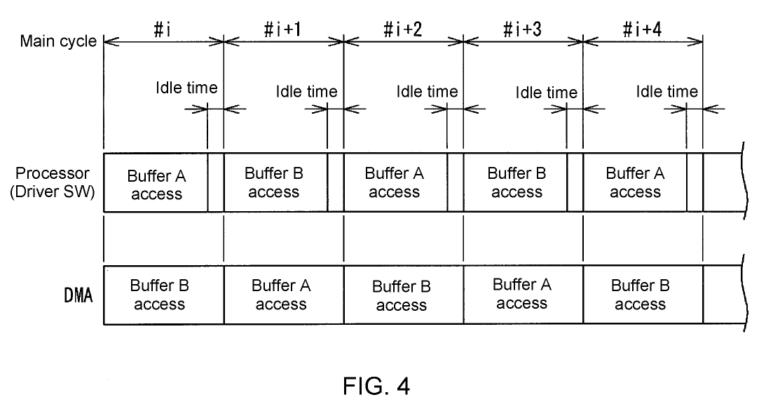

As a comparative example, data input/output between the processor 101 and the peripheral circuit 105 in a configuration using two buffers 200_A and 200_B (double buffer) will be described. FIG. 4 is a timing chart illustrating an example of buffer access timing in the double buffer configuration.

Hereinafter, the xth main cycle is also referred to as “main cycle #x.” The buffers 200_A and 200_B are also referred to as “buffer A” and “buffer B,” respectively. Similarly, the buffer 200_C is also referred to as “buffer C.” The receive buffer 200R_A is also referred to as “receive buffer A,” and the receive buffer 200R_B is also referred to as “receive buffer B.” The transmit buffer 200T_A is also referred to as “transmit buffer A,” and the transmit buffer 200T_B is also referred to as “transmit buffer B.” The receive buffer 200R_C is also referred to as “receive buffer C,” and the transmit buffer 200T_C is also referred to as “transmit buffer C.”

In the double buffer configuration, the DMA controller 104 needs to operate according to the main cycle. Let i be an integer variable. From the start of main cycle #i, the processor 101 (driver SW 120) accesses the buffer A. Specifically, the processor 101 reads data from the receive buffer A and writes data to the transmit buffer A.

At an intermediate point of main cycle #i, the reading of data from the receive buffer A and the writing of data to the transmit buffer A are completed. The period from the end of access to the buffer A until the end of main cycle #i is an idle time, during which access to the buffer A is suspended.

The DMA controller 104 accesses the buffer B during the period from the start to end of main cycle #i. In detail, data is transferred from the register 310_B to the receive buffer B by DMA, and data is transferred from the transmit buffer B to the register 310_A by DMA. Since the processor 101 is accessing the buffer A during main cycle #i as mentioned above, there is no conflict (overlap) between the processor 101 and the DMA for access to the same buffer.

At the end of main cycle #i, the access to the buffer B by DMA has been completed. From the start of main cycle #i+1, the processor 101 (driver SW 120) accesses the buffer B. Specifically, the processor 101 reads data from the receive buffer B and writes data to the transmit buffer B.

At an intermediate point of main cycle #i+1, the reading of data from the receive buffer B and the writing of data to the transmit buffer B are completed. The period from the end of access to the buffer B until the end of main cycle #i+1 is an idle time, during which access to the buffer B is suspended.

The DMA controller 104 accesses the buffer A during the period from the start to end of main cycle #i+1. In detail, data is transferred from the register 310_B to the receive buffer A by DMA, and data is transferred from the transmit buffer A to the register 310_A by DMA. Since the processor 101 is accessing the buffer B during main cycle #i +1 as mentioned above, there is no conflict (overlap) between the processor 101 and the DMA for access to the same buffer.

Similarly, in main cycle #i+2, the processor 101 accesses the buffer A and the DMA controller 104 accesses the buffer B. In main cycle #i+3, the processor 101 accesses the buffer B and the DMA controller 104 accesses the buffer A. In main cycle #i+4, the processor 101 accesses the buffer A and the DMA controller 104 accesses the buffer B. In this manner, the processor 101 alternately accesses the buffer A and the buffer B in each main cycle, and the DMA controller 104 alternately accesses the buffer B and the buffer A in each main cycle. Thus, buffer access is controlled in each main cycle so that the processor 101 and the DMA controller 104 will not simultaneously access the same buffer.

For example, if an interrupt occurs in the processor 101 and as a result access to the buffer A by the processor 101 during main cycle #i is delayed, the delay is acceptable as long as it is within the idle time. In other words, if the delay is shorter than the idle time, the processor 101 can complete its access to the buffer A within main cycle #i. That is, the processor 101 can finish reading from the receive buffer A and writing to the transmit buffer A by the end of main cycle #i.

If the delay is longer than the idle time, on the other hand, the processor 101 cannot complete its access to the buffer A within main cycle #i. In this case, the processor 101 does not finish reading from the receive buffer A, causing the data read by the processor 101 to be incomplete. Moreover, the processor 101 does not finish writing to the transmit buffer A, causing the data output to the register 310_A by DMA to be incomplete.

### Triple Buffer

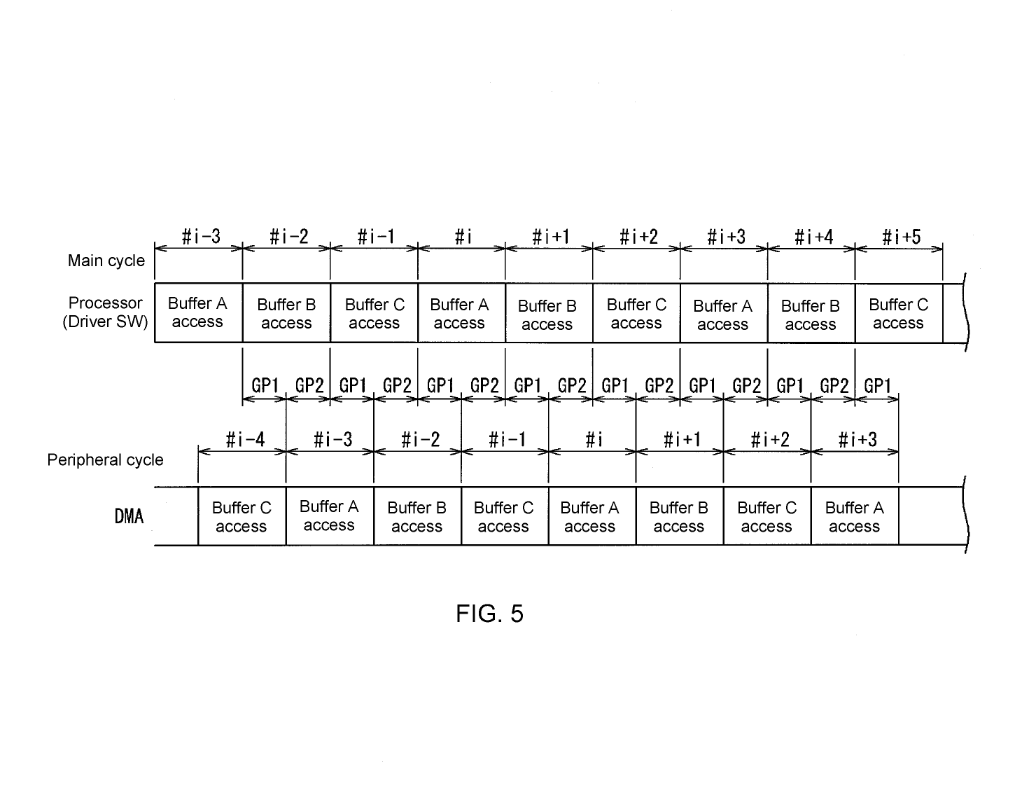

Next, data input/output between the processor 101 and the peripheral circuit 105 in the configuration using three buffers 200_A, 200_B, and 200_C (triple buffer configuration) according to the present disclosure will be described. FIG. 5 is a timing chart illustrating an example of buffer access timing in the triple buffer configuration.

In the triple buffer configuration, the DMA controller 104 operates according to the sub-cycle. The sub-cycle has the same length as the main cycle but differs in phase from the main cycle. In detail, sub-cycle #x starts during main cycle #x+1 and ends during main cycle #x+2. In a specific example, the phase of the sub-cycle lags the phase of the main cycle by 540°. In other words, sub-cycle #x starts when half of the main-cycle period has elapsed from the start of main cycle #x+1, and ends when half of the main-cycle period has elapsed from the start of main cycle #x+2.

Let i be an integer variable (where i > 3). From the start of main cycle #i, the processor 101 (driver SW 120) accesses the buffer A. Specifically, the processor 101 reads data from the receive buffer A and writes data to the transmit buffer A.

At the end of main cycle #i, the reading of data from the receive buffer A and the writing of data to the transmit buffer A are completed. Here, the period from the start to end of main cycle #i is a period allocated for access to the buffer A, and it is not necessary to perform reading of data from the receive buffer A or writing of data to the transmit buffer A up to the end of main cycle #i. In other words, the processor 101 only needs to complete reading of data from the receive buffer A and writing of data to the transmit buffer A by the end of main cycle #i.

From the start of main cycle #i+1, the processor accesses the buffer B. Specifically, the processor 101 reads data from the receive buffer B and writes data to the transmit buffer B.

At the end of main cycle #i+1, the reading of data from the receive buffer B and the writing of data to the transmit buffer B are completed.

Sub-cycle #i−1 starts during main cycle #i and ends during main cycle #i+1. The DMA controller 104 accesses the buffer C during the period from the start to end of sub-cycle #i−1. In detail, data is transferred from the register 310_B to the receive buffer C by DMA, and data is transferred from the transmit buffer C to the register 310_A by DMA. The data transferred from the transmit buffer C during sub-cycle #i−1 is the data written to the transmit buffer C by the processor 101 during main cycle #i−1. Since the processor 101 is accessing the buffer A and the buffer B during sub-cycle #i−1 as mentioned above, there is no conflict between the processor 101 and the DMA for access to the same buffer.

The end of sub-cycle #i−1 is at an intermediate point of main cycle #i+1 (i.e., when half of the main-cycle period has elapsed from the start of main cycle #i+1). Accordingly, main cycle #i+2 starts when half of the main-cycle period has elapsed from the end of sub-cycle #i−1. From the start of main cycle #i+2, the processor 101 accesses the buffer C. Specifically, the processor 101 reads data from the receive buffer C and writes data to the transmit buffer C. The data read from the receive buffer C by the processor 101 during main cycle #i+2 is the data transferred to the receive buffer C by DMA during sub-cycle #i−1.

Sub-cycle #i starts during main cycle #i+1 and ends during main cycle #i+2. The DMA controller 104 accesses the buffer A during the period from the start to end of sub-cycle #i. In detail, data is transferred from the register 310_B to the receive buffer A by DMA, and data is transferred from the transmit buffer A to the register 310_A by DMA. The data transferred from the transmit buffer A during sub-cycle #i is the data written to the transmit buffer A by the processor 101 during main cycle #i. Since the processor 101 is accessing the buffer B and the buffer C during sub-cycle #i, there is no conflict between the processor 101 and the DMA for access to the same buffer.

The end of sub-cycle #i is at an intermediate point of main cycle #i+2 (i.e., when half of the main-cycle period has elapsed from the start of main cycle #i+2). Accordingly, main cycle #i+3 starts when half of the main-cycle period has elapsed from the end of sub-cycle #i. From the start of main cycle #i+3, the processor 101 accesses the buffer A. Specifically, the processor 101 reads data from the receive buffer A and writes data to the transmit buffer A. The data read from the receive buffer A by the processor 101 during main cycle #i+3 is the data transferred to the receive buffer A by DMA during sub-cycle #i.

Sub-cycle #i+1 starts during main cycle #i+2 and ends during main cycle #i+3. The DMA controller 104 accesses the buffer B during the period from the start to end of sub-cycle #i+1. In detail, data is transferred from the register 310_B to the receive buffer B by DMA, and data is transferred from the transmit buffer B to the register 310_A by DMA. The data transferred from the transmit buffer B during sub-cycle #i+1 is the data written to the transmit buffer B by the processor 101 during main cycle #i+1. Since the processor 101 is accessing the buffer C and the buffer A during sub-cycle #i+1, there is no conflict between the processor 101 and the DMA for access to the same buffer.

The end of sub-cycle #i+1 is at an intermediate point of main cycle #i+3 (i.e., when half of the main-cycle period has elapsed from the start of main cycle #i+3). Accordingly, main cycle #i+4 starts when half of the main-cycle period has elapsed from the end of sub-cycle #i +1. From the start of main cycle #i+4, the processor 101 accesses the buffer B. Specifically, the processor 101 reads data from the receive buffer B and writes data to the transmit buffer B. The data read from the receive buffer B by the processor 101 during main cycle #i+4 is the data transferred to the receive buffer B by DMA during sub-cycle #i+1.

Sub-cycle #i+2 starts during main cycle #i+3 and ends during main cycle #i+4. The DMA controller 104 accesses the buffer C during the period from the start to end of sub-cycle #i+2. In detail, data is transferred from the register 310_B to the receive buffer C by DMA, and data is transferred from the transmit buffer C to the register 310_A by DMA. The data transferred from the transmit buffer C during sub-cycle #i+2 is the data written to the transmit buffer C by the processor 101 during main cycle #i+2. Since the processor 101 is accessing the buffer A and the buffer B during sub-cycle #i+2, there is no conflict between the processor 101 and the DMA for access to the same buffer.

As described above, the processor 101 repeatedly accesses the buffer A, the buffer B, and the buffer C in this order in each main cycle, and the DMA controller 104 repeatedly accesses the buffer C, the buffer A, and the buffer B in this order in each sub-cycle.

After at least half of the main-cycle period has elapsed from the end of access to the buffer A by the processor 101, access to the buffer A by DMA starts. Thus, a period during which neither the processor 101 nor the DMA controller 104 accesses the buffer A (hereinafter referred to as “gap period GP1”) is secured between an access period of the processor 101 to the buffer A and an access period of DMA to the buffer A. The length of the gap period GP1 is, for example, approximately half of the main-cycle period. The gap period GP1 is sufficiently longer than the idle time in the double buffer configuration. Accordingly, even if an interrupt occurs in the processor 101, the processor 101 can complete access to the buffer A before access to the buffer A by DMA starts.

After half of the main-cycle period has elapsed from the end of access to the buffer A by DMA, access to the buffer A by the processor 101 starts. In other words, a period during which neither the processor 101 nor the DMA controller 104 accesses the buffer A (hereinafter referred to as “gap period GP2”) is secured between an access period of DMA to the buffer A and an access period of the processor 101 to the buffer A. The length of the gap period GP2 is, for example, approximately half of the main-cycle period. The gap period GP2 is sufficiently longer than the idle time in the double buffer configuration. Accordingly, even if the processor 101 accesses the buffer A earlier, access to the buffer A by DMA is completed before the processor 101 starts accessing the buffer A. Although access to the buffer A has been described above as a representative example, the same applies to the buffers B and C.

### MODIFICATIONS

Although the phase delay of the sub-cycle relative to the main cycle is half of the main cycle in the above embodiment, the present disclosure is not limited to this. For example, the phase of the sub-cycle may lag the phase of the main cycle by 510° or more and 720° or less.

### SUPPLEMENTARY NOTE

The embodiments disclosed herein are illustrative in all respects and not restrictive. The scope of the present disclosure is indicated by the claims and not by the embodiments described above, and includes all modifications within the meaning and scope equivalent to the claims.

What is claimed is:

1. A vehicle-mounted device comprising:
an information processing circuit; and
a connector configured to be connected to an associated device related to processing of the information processing circuit,
wherein the information processing circuit includes:
a first buffer;
a second buffer;
a third buffer;
a processor configured to read or write data from or to each of the first buffer, the second buffer, and the third buffer;
an interface connected to the connector and configured to perform at least one of input and output of data with the associated device; and
a direct memory access controller configured to transfer data between a register included in the interface and each of the first buffer, the second buffer, and the third buffer,
the processor is configured to
read or write data from or to the first buffer in an ith main cycle,
read or write data from or to the second buffer in an (i+1)th main cycle, and
read or write data from or to the third buffer in an (i+2)th main cycle, and
the direct memory access controller is configured to
transfer data between the first buffer and the register during a period from an intermediate point of the (i+1)th main cycle to an intermediate point of the (i+2)th main cycle,
transfer data between the second buffer and the register during a period from an intermediate point of the (i+2)th main cycle to an intermediate point of an (i+3)th main cycle, and
transfer data between the third buffer and the register during a period from an intermediate point of the (i+3)th main cycle to an intermediate point of an (i+4)th main cycle, where i is a natural number variable.

2. The vehicle-mounted device according to claim 1,
wherein the information processing circuit is configured to output data to the associated device,
the first buffer includes a first transmit buffer,
the second buffer includes a second transmit buffer,
the third buffer includes a third transmit buffer, and
the direct memory access controller is configured to:
transfer data written to the first transmit buffer by the processor in the ith main cycle, from the first transmit buffer to the register during the period from the intermediate point of the (i+1)th main cycle to the intermediate point of the (i+2)th main cycle;
transfer data written to the second transmit buffer by the processor in the (i+1)th main cycle, from the second transmit buffer to the register during the period from the intermediate point of the (i+2)th main cycle to the intermediate point of the (i+3)th main cycle; and
transfer data written to the third transmit buffer by the processor in the (i+2)th main cycle, from the third transmit buffer to the register during the period from the intermediate point of the (i+3)th main cycle to the intermediate point of the (i+4)th main cycle.

3. The vehicle-mounted device according to claim 2, wherein the associated device includes an actuator, and
the data is data for controlling the actuator.

4. The vehicle-mounted device according to claim 1, wherein the associated device outputs data to the information processing circuit,
the first buffer includes a first receive buffer,
the second buffer includes a second receive buffer,
the third buffer includes a third receive buffer, and
the processor is configured to:
read, from the first receive buffer, output data from the associated device that has been transferred from the register to the first receive buffer by the direct memory access controller during a period from an intermediate point of a (i−2)th main cycle to an intermediate point of a (i−1)th main cycle, in the ith main cycle;
read, from the second receive buffer, output data from the associated device that has been transferred from the register to the second receive buffer by the direct memory access controller during a period from an intermediate point of the (i−1)th main cycle to an intermediate point of the ith main cycle, in the (i+1)th main cycle; and
read, from the third receive buffer, output data from the associated device that has been transferred from the register to the third receive buffer by the direct memory access controller during a period from an intermediate point of the ith main cycle to an intermediate point of the(i+1)th main cycle, in the (i+2)th main cycle.

5. The vehicle-mounted device according to claim 4, wherein the associated device includes a sensor, and
the data is data output from the sensor.

6. An information processing circuit comprising:
a first buffer;
a second buffer;
a third buffer;
a processor configured to read or write data from or to each of the first buffer, the second buffer, and the third buffer;
an interface connected to an associated device and configured to perform at least one of input and output of data with the associated device; and
a direct memory access controller configured to transfer data between a register included in the interface and each of the first buffer, the second buffer, and the third buffer,
wherein the processor is configured to
read or write data from or to the first buffer in an ith main cycle,
read or write data from or to the second buffer in an (i+1)th main cycle, and
read or write data from or to the third buffer in an (i+2)th main cycle, and
the direct memory access controller is configured to
transfer data between the first buffer and the register during a period from an intermediate point of the (i+1)th main cycle to an intermediate point of the (i+2)th main cycle,
transfer data between the second buffer and the register during a period from an intermediate point of the (i+2)th main cycle to an intermediate point of an (i+3)th main cycle, and
transfer data between the third buffer and the register during a period from an intermediate point of the (i+3)th main cycle to an intermediate point of an (i+4)th main cycle, where i is a natural number variable.
